(19) United States
(12) Patent Application Publication
(10) Pub. No.: US 2003/0067387 A1
(43) Pub. Date: Apr. 10, 2003

(54) Remote control and management system

(76) Inventors: Sung Bok Kwon, Seoul (KR); Gyu Sang Jung, Seoul (KR); Yong Hoe Kim, Seoul (KR); Kwang Seok Seo, Jeonju-City (KR)

Correspondence Address: CANTOR COLBURN, LLP, 55 GRIFFIN ROAD SOUTH, BLOOMFIELD, CT, 06002

(21) Appl. No.: 10/264,674

(22) Filed: Oct. 4, 2002

(30) Foreign Application Priority Data
Oct. 5, 2001 (KR) 2001-61538

(51) Int. Cl. G08B 21/00

(52) U.S. Cl. 340/540; 340/531; 348/143

(57) ABSTRACT

The present invention discloses a remote control and management system comprising a remote management unit for registering remote sites, connection setting and system setting and managing by being interacting with a local terminal which is connected with a plurality of monitoring devices for monitorng the remote site, a remote monitoring unit for outputting audio/video data input from the monitoring devices, and event detecting unit for analyzing the monitored data transmitted from the monitoring devices, generating an event and reporting event occurrenct to the remote management unit and the remote monitoring unit, and a remote retrieving unit for retrieving and outputting the audio/video data corresponding to the event.

The remote control and management system in accordance with the present invention provides functions of remote management for monitorng remote equipments or sites, security inspection, audio/video data retrieving. Further each of the functions is interacting with the others, so that a user can easily and conveniently take in the event and effectiely monitor remote sites.

### BACKGROUND OF INVENTION

1. Field of the Invention

The present invention relates to a remote control and management system providing various functions of remote equipments management, security examination, audio/video data searching for remote monitoring.

2. Description of the Related Art

In recent years, a remote control and management system has been widely demanded for the prevention of crime or emergency in places where security is necessary such as public buildings (offices), parking lots, private houses, apartments, laboratory and banks.

FIG. 1 is a block diagram of a remote control and management system in accordance with the conventional art.

Referring to FIG. 1, the remote control and management system comprises a plurality of cameras 30 installed in a plurality of remote sites 40, a video matrix switch 20 connected with the cameras via a cable, monitors 11 for displaying video signals transmitted from the cameras 30, input devices 12 such as a keyboard and a controller 10.

The video signals input by the cameras 30 are transmitted to the video matrix switch 20 through the cable, and then to the monitors 11.

The controller 10 comprises an additional storage device (not shown) where the transmitted video signals are stored, so that the user can selectively access the transmitted video signals using the video matrix switch 20 and monitors 11. That is, the user can select the cameras to be displayed on the monitor.

However, the conventional remote control and management system is not convenient because identification code of the cameras 30 should be additionally stored and the user can selects the cameras to display on the monitor using the input devices 12 associated with the controller 10.

To solve the problem involved in the conventional remote control and management system in FIG. 1, an improved remote control and management system is suggested. The improved remote control and management system comprises a plurality of local terminals that is connected to the cameras via the cable, and a computer terminal having a control program is connected with the local terminals via communication network such as the local area network (LAN). The remote control is accomplished using the control program.

In general, the improved remote control and management system based on digital data processing firstly converts video signals transmitted from the cameras to digital data in the course of compressing and encrypting the video signals in the local terminal and then transmits the digital data to the control program through the communication network. The digital data transmitted from the cameras can be accessed, displayed, printed and stored by the control program, and such accessing, displaying, printing or storing operations are controlled based on a graphic user interface (GUI), so that the improved remote control and management system provides the user with many friendly functions.

However, the control program has a limited simple function of monitoring the remote sites by receiving, displaying and storing the video signals from the cameras. Accordingly, the improved remote control and management system cannot provide various functions such as controlling and supervising remote equipments, security examination, and audio/video data searching.

For example, in case an event such as abnormal movement or crime alarm detecting alarm is occurred is took by the cameras, the user has to retrieve the video data to know what kind of event happened by using the control program. Further, the user has to check occurrence of the event and content of the event, so that it is difficult to know what and when the event happened at first sight.

### SUMMARY OF THE INVENTION

Therefore, it is an object of the present invention to provide a remote control and management system having various functions of managing remote equipments, security examination, audio/video data retrieving for remote control, wherein each of the functions is relatively operated with each others in response to an event that happened, so that the user may easily take in circumstance of the event.

In accordance with one aspect of the present invention, there is provided a remote control and management system that is associated with monitoring devices being comprised cameras for acquring video data of remote sites, a microphone for acquiring voice or audio data of the remote sites and a plurality of sensors, and a local terminal connected with the monitoring devices via a cable for receiving monitored data acqured by the monitoring devices and transmitting the same to an external device through communication network, and operated by being connected with the monitoring devices and the local terminal through the communication network, comprising: a database unit for storing data acquired during the remote control and managment system is operating; an event detecting unit for analyzing the monitored data transmitted from the monitoring devices via the local terminal, detecting an event to be reported to a user, and storing content of the event into the database unit; a remote management unit for registering remote sites to be monitored, connection setting to the remote sites, setting and managing a plurality of equipments belonging to the remote control and management system, receiving and outputting the event detected by the event detecting unit; a remote monitoring unit for outputting the audio/video data transmitted from the monitoring devices in real time and storing the transmitted audio/video data to the database section, and outputting conent of the event when the event occurrence is reported by the event detecting unit; an event retrieving unit for retrieving the audio/video data stored in the database unit and acquired during the event is occurred when the user demands the audio/video data corresponding to the event detected by the event detecting unit, and a controller for controlling interaction of the database unit, the event detecting unit, the remote management unit, the remote monitoring unit and the event retrieving unit and data flow.

The event detecting unit comprises: a detecting area setting module for allowing the user to set detecting area where movement should be detected out of the video data; an event condition setting module for allowing the user to set items that are regarded as the event; an event detecting module for analyzing the monitored data transmitted from the monitoring devices and generating event occurrence message when the event set by the event condition setting module is detected; and an event reporting module for reporting the event occurrence message along with event occurrence time to the remote monitoring unit and the remote management unit.

The remote management unit comprises: a remote site registration/modification/deletion module for registering a new remote site, modifying information of registered remote site and deleting the remote site; a remote site connection setting module for connecting the remote site to be monitored, controlled or managed, setting a plurality of information of the remote site and upgrading the set information of the remote site; a remote site circumstance and event outputting module for receiving current status of the remote site and event occurrence at the remote sites from the remote site connection setting module and outputting the received current status of the remote site and event occurrenct at the remote sites; and a remote site record outputting module for calling a plurality of information related to remote site connection setting and the event occurrence from the database unit and outputting the called information.

The remote monitoring unit comprises: an audio/video data receiving/outputting module for outputting the audio/video data after receiving the audio/video data transmitted from the monitoring devices at the remote sites via the local terminal; an image frame setting module for adjusting an image of the video data by dividing or resizing in response to the user's demand; and an event circumstance outputting module for outputting the event occurrence message reported from the event detecting unit. The remote monitoring unit further comprises a favorites setting module for registering the remote sites where the user frequently monitors and the remote site information of corresponding remote sites, so that the remote sites registered in the favorites are automatically and sequentially connected and monitored in turn by one click instruction from the user.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a schematic block diagram of a remote control and management system in accordance with the conventional art;

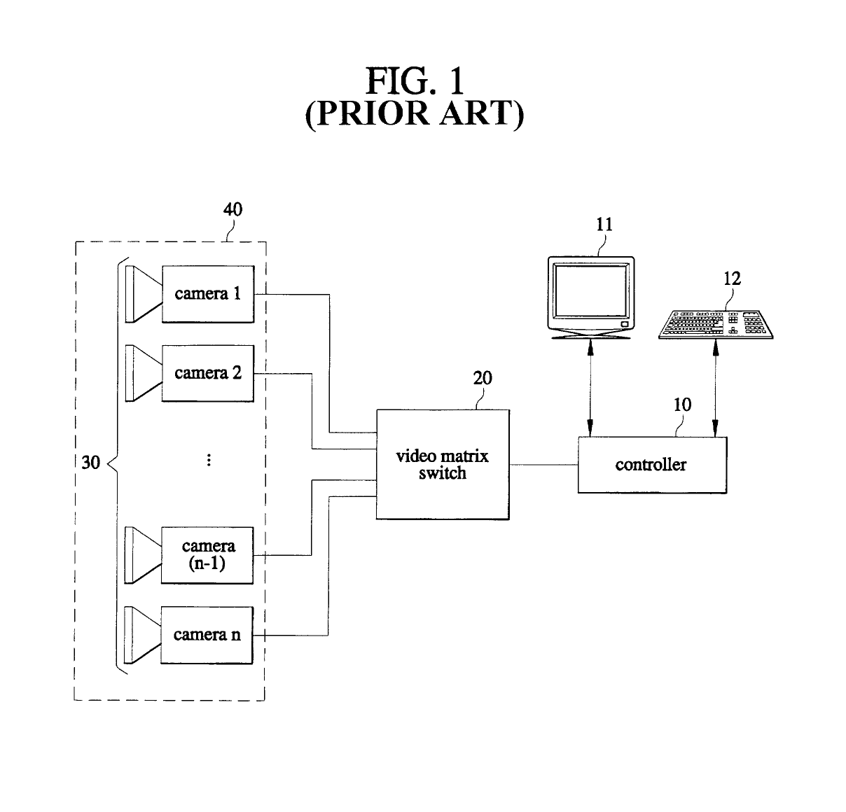

FIG. 2 is a schematic diagram of an application system of a remote control and management system in accordance with the present invention;

FIG. 3 is a block diagram of the remote control and management system in accordance with the present invention; and

FIG. 4 is a flow chart for explaining operation of the remote control and management system in accordance with the present invention.

### DETAILED DESCRIPTION OF PREFERRED EMBODIMENTS

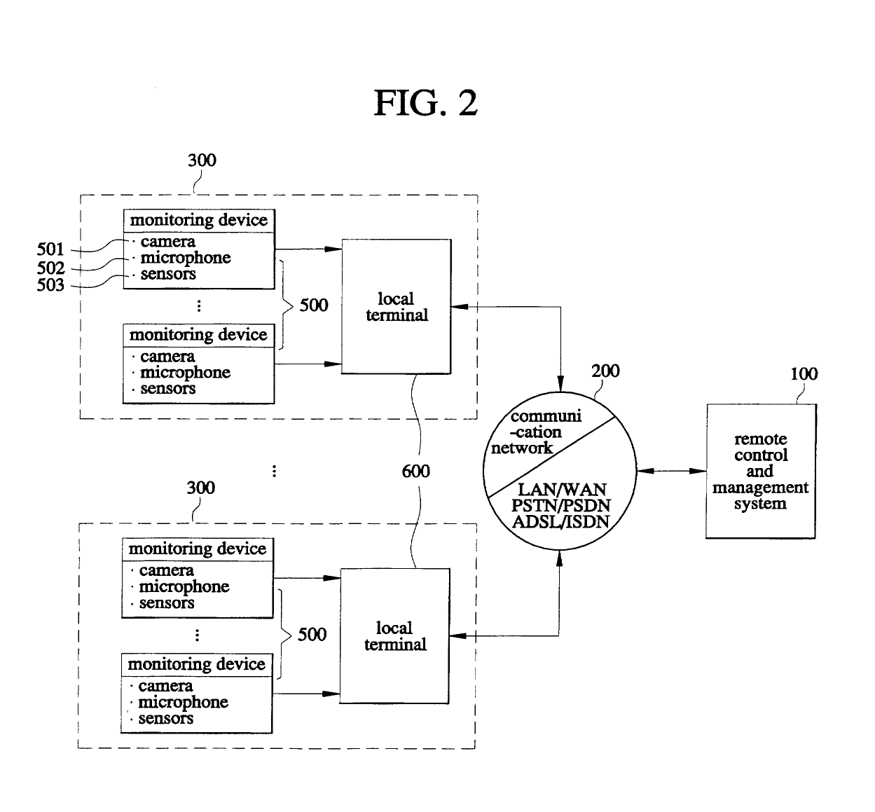

FIG. 2 is a schematic diagram for showing an application system of the remote control and management system in accordance with the present invention.

A plurality of monitoring devices 500 being comprised of cameras 501 for acquiring video data, microphones 502 for acquiring audio data and various kinds of sensors 503 such as thermal sensor or magnetic sensor are installed in a plurality of remote sites. The monitoring devices are connected with each corresponding local terminal 600 via a cable.

The local terminal 600 converts the monitored data (audio data, video data, sensed data) acquired by the monitoring devices 500 by compressing and encrypting the same to interface data which conforms the communication network, and transmitting the converted interface data to a remote control and management system 100 via the communication network 200.

The communication network 200 may be a local area network (LAN), a wide area network (WAN), a public switched telephone network (PSTN), a public switched data network (PSDN), an asymmetric digital subscriber line (ADSL) or an integrated services digital network (ISDN).

The remote control and management system 100 receives the data transmitted from the local terminals 600 and provides the user with a lot of control and management functions for the remote monitoring or supervisory.

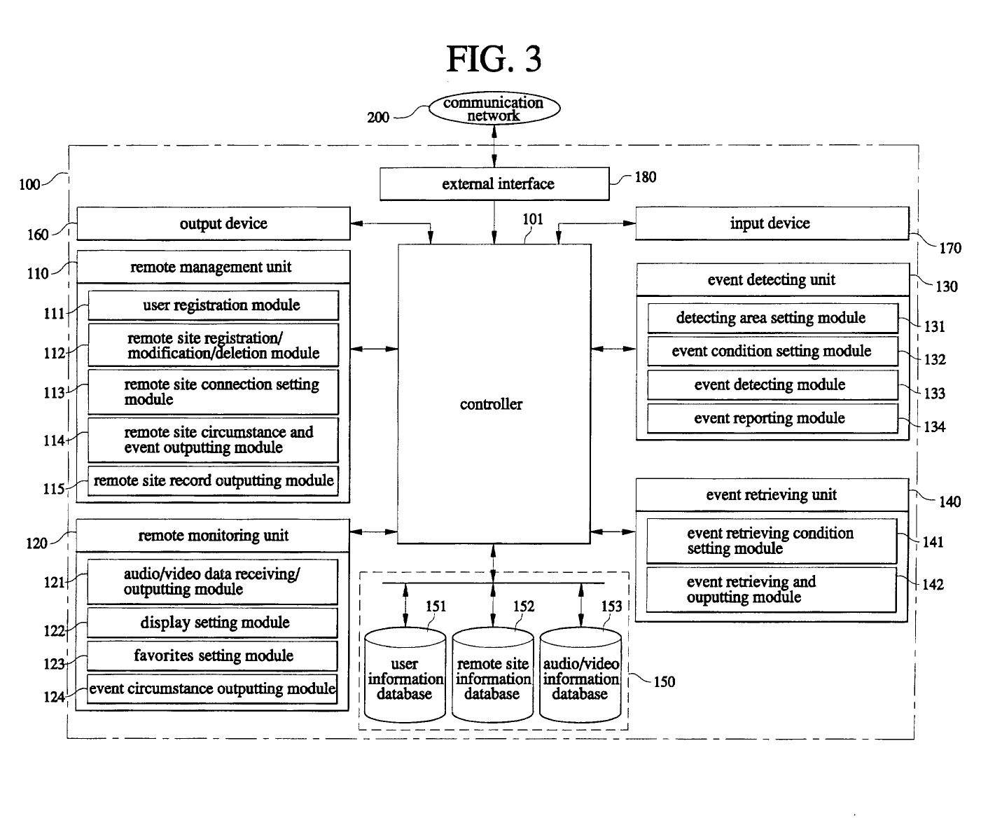

FIG. 3 is a block diagram of the remote control and management system in accordance with one embodiment of the present invention.

The remote control and management system 100 communicates with the local terminals 600 installed in the remote sites 300 using an external interface unit 180, thereby receiving and transmitting the data to the local terminals 600. The remote control and management system 100 comprises an input device 170 such as a keyboard and a mouse, and an output device such as a monitor selected among a liquid crystal display (LCD), a cathode-ray tube (CRT) and a plasma display panel (PDP).

A remote management section 110 comprises a user registration module 111, a remote site registration/modification/deletion module 112, a remote site connection setting module 113, a remote site circumstance and event outputting module 114 and a remote site record data outputting module 115, and performs a plurality of setting and management functions.

The user registration module 111 receives user information from a user, allocates an identification code (identification number or password) to the user so that the user is allowed to use the remote control and management system 100 and records the user information into a user information database 151 of a database unit 150.

The user must log in the remote control and management system 100 with the identification code allocated by the user registration module 111 for using the remote control and management system 100.

The remote site registration/modification/deletion module 112 provides the user with functions to register, modify and delete the remote site information about the remote sites 300. The registered, modified or deleted remote site information is saved or updated in a remote site information database 152.

The remote site connection setting module 113 provides the user with a function to set a plurality of information to the remote sites 300 by connecting the remote sites 300 to be monitored, controlled and managed. The remote sites 300 are upgraded or controlled in response to the information set by the user in a batch job process.

The remote site circumstance and event outputting module 114 informs the user of current status of the remote equipments (monitoring devices 500 and local terminals 600) in a batch job process wherein the current status includes recording status or operating status (normal or error) of the remote equipments. Further, the remote site circumstance and event outputting module 114 outputs circumstance of the events informed by the event detecting unit 130 listing the events on the output device 160. In case the user selects one of the event from the listed events, the event retrieving/outputting module 142 of the event retrieving unit 140 is called, so that the user easily and conveniently take in the circumstance of the event.

The event is a matter that is necessarily reported to the user out of the monitored data. The event includes abnormal movements, crime or accident alarms.

The remote site record outputting module 115 retrieves a plurality of recorded information such as event occurrence and remote site connection status from the remote site information database 132 and outputting the retrieved information.

It is preferable that the remote site record outputting module 115 allows the user to retrieve the record information from the remote information data base 152 by inputting the retrieving condition such as event occurrence time period and event type and output the retrieved data to the output device 160.

On the other hand, a remote monitoring unit 120 comprises an audio/video data receiving/outputting module 121, a display setting module 122, a favorites setting module 123 and an event circumstance outputting module 123. The remote monitoring unit 120 receives audio/video data inputted by the monitoring device 500 via the local terminals 600 and the external interface unit 180 and outputs the received audio/video data to the output devices 160. That is, the remote monitoring unit 120 outputs the event circumstances of the remote sites 300.

The audio/video data receiving/outputting module 121 receives the audio/video data from the monitoring devices 500 at the remote sites which are set by the remote site connection setting module 113 and outputs the received audio/video data to the outputting devices 160.

The display setting module 122 configures and divides an image frame for displaying the video data received from the audio/video data receiving/outputting module 121 in the sake of user convenience.

The favorites setting module 123 allows the user to register the remote sites where the user frequently wants to monitor and remote site connection setting information of the corresponding remote sites in favorites.

Accordingly, the user may monitor a plurality of remote sites with one click instruction by putting the plurality of remote sites where the user wants to monitor in favorites, so that the remote sites contained in the favorites are automatically and sequentially connected and monitored in turn. The automatic monitoring using favorites function may be continuously performed during a predetermined. That is, the remote sites to be monitored are registered in the favorites in a database in advance, and then all registered remote sites are automatically monitored in turn by one click instruction.

The event circumstance outputting module 124 outputs list of the events that are occurred at the remote sites 300, captured by the monitoring devices 500 and output from the audio/video data receiving/outputting module 121.

When the user selects one event from the list, the event retrieving/outputting module 142 is called, so that the user can easily take in the circumstance of the event.

The event detecting unit 130 comprises a detecting area setting module 131, an event condition setting module 132, an event detecting module 133 and an event reporting module 134. The event detecting unit 130 extracts the event from the monitored data transmitted from the local terminal 600 in accordance with the predetermined method, generates an event occurrence message and reports the event occurrence to the remote monitoring unit 120 and the remote management unit 110.

The event is defined as a material matter. The video data captured by the cameras of the monitoring devices 500 are analyzed and then in case of detecting abnormal movement from the audio/video data, “movement event” is generated by the event detecting unit because the abnormal movements intimates crime or emergency occurrence. Further, in case of detecting alarm from the sensors 503 of the monitoring devices 500, “alarm event” is generated.

The detecting area setting module 131 allows the user to set area for detecting the “movement event” when the movement is detected in the video data transmitted from the cameras 501.

For example, when the video data transmitted from the camera 501 is showing inside of an office and the user wants to set the area only around a moneybox as the movement event detecting area, the user may set the area around moneybox as the movement event detecting area out of the video data.

Accordingly, a lots of normal movements happened in the offices are not regarded as the event but only movement around the moneybox is regarded as the event, so that accuracy of event detection is improved.

The event condition setting module 132 sets event condition for extracting event items from the monitored data transmitted from the monitoring devices 500.

For example, sensors 503 in the remote site 300 detects “door open” for 24 hours a day and may generate the “alarm event” only when the “door open” is detected other than daily working time by setting the event condition (working time) using the event condition setting module 132.

The event detecting module 133 analyzes the monitored data (audio/video/sensed data) transmitted from the local terminal 600, extracts the event such as the “movement event” or “alarm event”, reports the event occurrence to the event reporting module 134 and then stores the monitored audio/video/sensed data corresponding to the event and event occurrence time.

Further, the event detecting module 133 provides the user with a function to control the cameras 501. For example, the user can remote adjust brightness/luminosity/chroma/color of the cameras and remote control pan, zoom, focus and preset of the cameras. Further, in case of occurring the “movement event”, the event detecting module 133 makes the camera to track a moving object causing the “movement event” and take pictures of the moving object in zoom.

The event reporting module 134 reports the event occurrence and event occurrence time to the remote monitoring unit 120 and remote management unit 110 when the event detecting module 133 detects the event.

The event retrieving unit 140 comprises an event retrieving condition setting module 141 and an event retrieving/outputting module 142. The event retrieving unit retrieves the audio/video data which corresponds to the event and acquired during the event occurrence time from the database unit 150 in response to the user's demand and outputs the retrieved results to the outputting devices 160.

The event retrieving condition setting module 141 allows the user to set the retrieving condition for retrieving the event. The condition may include the event occurrence time.

The event retrieving/outputting module 142 retrieves the audio/video data matched with the retrieving condition that is set by the user from the database unit 150 and outputs the retrieved audio/video data.

On the other hand, the controller 101 controls the operation of the all units 110-180 comprising the remote control and management system 100 and data flow through the system 100.

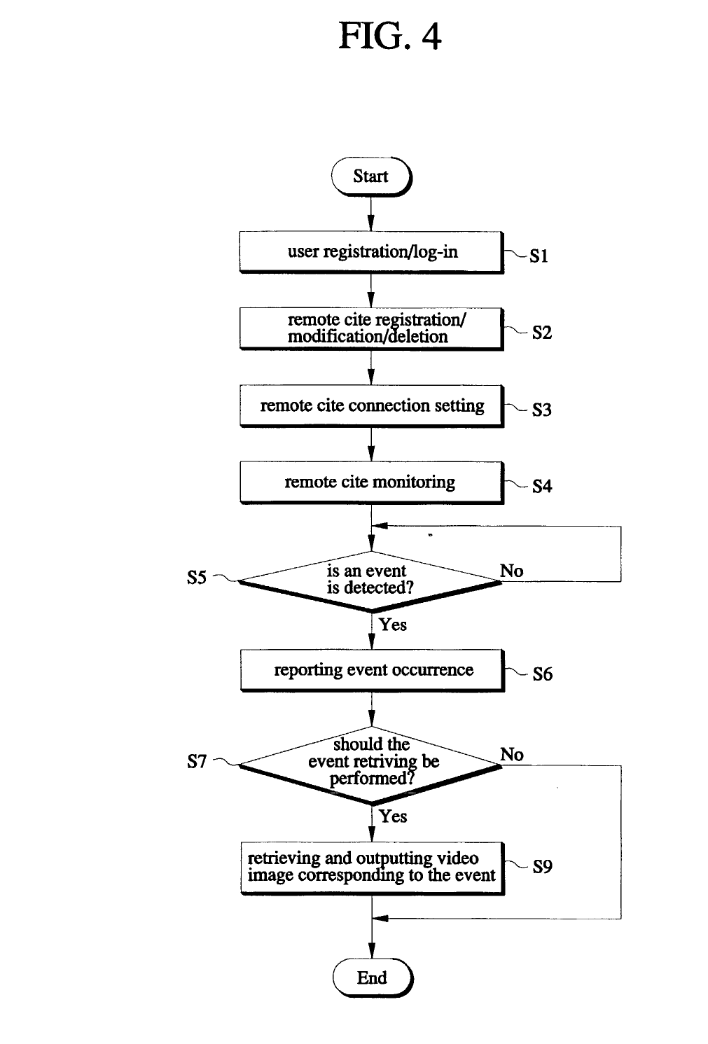

FIG. 4 is a flow chart for showing operation of the remote control and management system in accordance with the present invention.

First, the remote management unit 110 is called by the user. The user registers user information using the user registration module 111, receives identification code from the user registration module 111. Next, the user log ins using the identification code. Step S1.

Next, the user may register a new remote site 300, or may modify or delete the registered remote site 300 by calling the remote site registration/modification/deletion module 112. Step S2. The registered, deleted or modified remote site information is updated and saved in the remote site information database 152.

After completing registering/modifying/deleting the remote site information, the user connects the remote sites to be monitored and controlled by calling the remote site connection setting module 113, and upgrades the remote site connection setting of the remote control and management system 100. Step S3.

After completing setting of the remote site connection, monitored data (audio/video/sensed data) is transmitted from the monitoring devices 500 via local terminal 600, so that the user may monitor the circumstance of the remote sites 300 by reviewing the audio/video data. Step S4

The audio/video data transmitted to the local terminal 600 from the remote sites 300 are stored in the audio/video information database 153 of the database unit 500.

On the other hand, the event detecting module 133 of the event detecting unit 130 analyzes the monitored data transmitted from the monitoring devices 500 in the remote site 300. Step S5. In case of sensing abnormal movement or alarm, event occurrence message is generated and transmitted to the event reporting module 134.

In case of being transmitted the event occurrence message, the event reporting module 134 reports the event occurrence after receiving the event occurrence message along with event occurrence time to the remote site circumstance and event outputting module 114 of the remote control unit 110 and the event circumstance outputting module 124 of the remote monitoring unit 120. Step S6.

The remote site circumstance and event outputting module 114 and the event circumstance outputting module 124 informs the user of occurring the event by sending the event occurrence message to the user in real time.

More preferably, the event occurrence message is a list of events. In case the user selects one event from the list, the event retrieving/outputting module 142 may be called. Step S7. Then, the event retrieving/outputting module 142 retrieves audio/video data from the audio/video information database 153, extracts the audio/video data corresponding to the selected event and outputs the retrieved audio/video data to the output device 160. Step S9.

Further, in case the user demands a plurality of events by setting the retrieving condition (for example, all events occurred from Monday afternoon to Wednesday morning, or all events monitored by the first camera) using the event retrieving condition setting module 114, all events matched with the set retrieving condition may be outputted for the sake of user's searching convenience.

On the other hand, if the event detecting module 133 of the event detecting unit 130 detects an important event at a certain remote site 300, the controller 101 calls the remote monitoring unit 120 and the event retrieving unit 140 and outputs the monitored data with respect to the important event. At this time, the controller controls a plurality of cameras in the corresponding remote site 300 where the important event is occurred for monitoring and tracking the event, further controls the monitors to display the video data transmitted from the plurality of cameras 501.

The remote site record outputting module of the remote management unit 110 manages remote site information such as event occurrence and connection status stored in the remote site information database 152 and outputs the remote site information in response to the user's demand, so that the remote sites are effectively managed and controlled.

As discussed above, the remote control and management system in accordance with the present invention provides various functions of remote equipment management, security examination and audio/video data retrieving wherein each of the functions is operated depending on the others, so that the remote control and management system is a convenient for a user to monitor and detect event occurrence.

Further, the remote control and management system in accordance with the present invention provides the user with the remote management function for connection setting between the remote sites and the control and management system and the remote monitoring function for monitoring the remote sites using a graphic user interface (GUI) in sake of user's convenience.

The unallowable movement, theft, crime or accident at the remote sites may be detected as the event, and then reported to the remote control unit and the remote monitoring unit, so that the user may be informed of the event occurrence in real time. Accordingly, the remote control and management system in accordance with the present invention may be helpful in security control and management of the remote sites.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A remote control and management system associated with monitoring devices being comprised cameras for acquring video data of remote sites, a microphone for acquiring voice or audio data of the remote sites and a plurality of sensors, and a local terminal connected with the monitoring devices via a cable for receiving monitored data acquired by the monitoring devices and transmitting the same to an external device through communication network, and operated by being connected with the monitoring devices and the local terminal through the communication network, comprising:
a database unit for storing data acquired during the remote control and managment system is operating;
an event detecting unit for analyzing the monitored data transmitted from the monitoring devices via the local terminal, detecting an event to be reported to a user, and storing content of the event into the database unit;
a remote management unit for registering remote sites to be monitored, connection setting to the remote sites, setting and managing a plurality of equipments belonging to the remote control and management system, receiving and outputting the event detected by the event detecting unit;
a remote monitoring unit for outputting the audio/video data transmitted from the monitoring devices in real time and storing the transmitted audio/video data to the database section, and outputting conent of the event when the event occurrence is reported by the event detecting unit;
an event retrieving unit for retrieving the audio/video data stored in the database unit and acquired during the event is occurred when the user demands the audio/video data corresponding to the event detected by the event detecting unit, and
a controller for controlling interaction of the database unit, the event detecting unit, the remote management unit, the remote monitoring unit and the event retrieving unit and data flow.

2. The remote control and management system according to claim 1, wherein the communication network is one selected from LAN, WAN, PSTN, PSDN, ADSL and ISDN.

3. The remote control and management system according to claim 1, wherein the event occurrence is detected when unallowable movement is detected from the video data transmitted from the camera and/or alarm is detected by the sensors.

4. The remote control and management system according to claim 1, wherein the event detecting unit comprises:
a detecting area setting module for allowing the user to set detecting area where movement should be detected out of the video data;
an event condition setting module for allowing the user to set items that are regarded as the event;
an event detecting module for analyzing the monitored data transmitted from the monitoring devices and generating event occurrence message when the event set by the event condition setting module is detected; and
an event reporting module for reporting the event occurrence message along with event occurrence time to the remote monitoring unit and the remote management unit.

5. The remote control and management system according to claim 4, wherein the event detecting module provides the user with a function to adjust brightness, luminosity, chroma and color of the camera and to control operation of the camera.

6. The remote control and management system according to claim 4, wherein the event detecting module controls the camera to track and observe in zoom an object that caused movement event when the movement event is detected.

7. The remote control and management system according to claim 1, wherein the remote management unit comprises:
a remote site registration/modification/deletion module for registering a new remote site, modifying information of registered remote site and deleting the remote site;
a remote site connection setting module for connecting the remote site to be monitored, controlled or managed, setting a plurality of information of the remote site and upgrading the set information of the remote site;
a remote site circumstance and event outputting module for receiving current status of the remote site and event occurrence at the remote sites from the remote site connection setting module and outputting the received current status of the remote site and event occurrenct at the remote sites; and
a remote site record outputting module for calling a plurality of information related to remote site connection setting and the event occurrence from the database unit and outputting the called information.

8. The remote control and management system according to claim 7, wherein the remote site circumstance and event outputting module reports that operation status of the monitoring devices and the local termianl is normal or error the user in a batch-job.

9. The remote control and management system according to claim 7, wherein the remote site record outputting module receives retrieving condition from the user and outputting the remote site information matched with the retrieving condition.

10. The remote control and management system according to claim 1, wherein the remote monitoring unit comprises:
an audio/video data receiving/outputting module for outputting the audio/video data after receiving the audio/video data transmitted from the monitoring devices at the remote sites via the local terminal;
an image frame setting module for adjusting an image of the video data by dividing or resizing in response to the user's demand; and
an event circumstance outputting module for outputting the event occurrence message reported from the event detecting unit.

11. The remote control and management system according to claim 10, wherein the remote monitoring unit further comprises a favorites setting module for registering the remote sites where the user frequently monitors and the remote site information of corresponding remote sites, so that the remote sites registered in the favorites are automatically and sequentially connected and monitored in turn by one click instruction from the user.

12. The remote control and management system according to claim 1, wherein the event retrieving unit comprises:
an event retrieving conditon setting module for receiving retrieveing condition for retrieving the audio/video data acquired during the event occurrence time; and
an event retriving/outputting module for retrieving the audio/video data matched with the retrieving condition from the database unit and outputting the retrieved data.

13. The remote control and management system according to claim 1, wherein the event occurrences reported to the remote management unit and the remote monitoring unit are outputted as a list of events, if the user selects one event from the list, the event retrieving/outputting module is automatically called, so that the audio/video data corresponding to the selected event occurrence are retrieved and outputted.

14. The remote control and management system according to claim 1, whrein the controller calls the remote monitoring unit and remote retrieving unit when an important event is detected at a certain remote site by the event detecting module of the event detecting unit, drives a plurality of monitoring devices at the corresponding remote site, outputs the monitored data with respect to the important event, and dividing an image of the monitored data into a proper size.
